(19) United States
(12) Patent Application Publication
(10) Pub. No.: US 2024/0429846 A1
(43) Pub. Date: Dec. 26, 2024

(54) ELECTRIC WORK MACHINE AND MOTOR CONTROL METHOD

(71) Applicant: MAKITA CORPORATION, Anjo-shi (JP)

(72) Inventor: Changpil SHIN, Seoul (KR)

(73) Assignee: MAKITA CORPORATION, Anjo-shi (JP)

(21) Appl. No.: 18/746,588

(22) Filed: Jun. 18, 2024

(30) Foreign Application Priority Data
Jun. 20, 2023 (JP) 2023-100976

(51) Int. Cl. H02P 23/02; B23D 49/16; B25F 5/02

(52) U.S. Cl. CPC H02P 23/02; B25F 5/02; B23D 49/162

(57) ABSTRACT

An electric work machine according to one aspect of the present disclosure includes a motor, a drive circuit, and a control circuit. The control circuit includes a physical quantity obtainer, a variation obtainer, a sum calculator, and a drive controller. The physical quantity obtainer obtains a physical quantity every time a detection timing arrives. The variation obtainer obtains a variation of the physical quantity every time the detection timing arrives. The sum calculator calculates a sum value every time the detection timing arrives. The sum value corresponds to a sum of one or more variations. The drive controller controls the motor in accordance with a first control system via the drive circuit based on the sum value satisfying a no-load detection requirement.

### CROSS-REFERENCE TO RELATED APPLICATIONS

The present application claims the benefit of Japanese Patent Application No. 2023-100976 filed on Jun. 20, 2023 with the Japan Patent Office, the entire disclosure of which is incorporated herein by reference.

### BACKGROUND

The present disclosure relates to a technique of controlling a motor in an electric work machine.

Japanese Patent No. 6154242 discloses an electric machinery tool configured to execute soft no-load control. In the soft no-load control, the output of a motor is suppressed from the start of drive of the motor until the load state of the motor is detected. When the load state of the motor is detected, the soft no-load control is released.

### SUMMARY

After the soft no-load control is released, the motor may vary from a load state to a no-load state. For example, it is assumed that the electric machinery tool is configured to be able to cut a workpiece with a saw blade. In this case, the saw blade cutting the workpiece may be temporarily separated from the workpiece, so that the motor may vary from the load state to the no-load state.

In a case where the motor varies from the load state to the no-load state, if the motor is appropriately controlled in response to the varying (for example, the soft no-load control is executed again), the convenience of the electric machinery tool is enhanced. For this purpose, it is desired that the no-load state of the motor can be accurately detected.

One aspect of the present disclosure desirably provides an electric work machine capable of accurately detecting a no-load state of a motor.

One aspect of the present disclosure provides an electric work machine including a motor, a drive circuit, and a control circuit.

The motor is configured to drive a driven tool attached to the electric work machine. The drive circuit is configured to drive the motor. The control circuit includes a physical quantity obtainer, a variation obtainer, a sum calculator, and a drive controller.

The physical quantity obtainer obtains a physical quantity every time a detection timing arrives. The physical quantity is related to an operating state of the motor.

The variation obtainer obtains a variation every time the detection timing arrives. The variation corresponds to an increased amount (or an increase amount) of the physical quantity from that obtained at the detection timing of last time to that obtained at the detection timing of this time.

The sum calculator calculates a sum value every time the detection timing arrives. The sum value corresponds to a sum of one or more variations. Each of the one or more variations corresponds to the variation obtained at the corresponding detection timing during a first period. The first period is from a first calculation start timing to the detection timing of this time.

The drive controller controls the motor in accordance with a first control system via the drive circuit based on the sum value calculated by the sum calculator having satisfied or satisfying a no-load detection requirement. The no-load detection requirement is required to detect no application of a load to the motor.

The sum value satisfying the no-load detection requirement corresponds to the motor being in a no-load state. The no-load state corresponds to a state where the load is not applied to the motor. The no-load state includes a state where the load is not applied to the motor at all. The no-load state may include a state where the load with a predetermined magnitude or less is applied to the motor.

In the electric work machine configured as described above, it is detected that the motor is in the no-load state on the basis of the sum value of the variations. Therefore, it is possible to accurately detect that the motor is in the no-load state.

Another aspect of the present disclosure provides a motor control method used in an electric work machine, the motor control method including:
obtaining a physical quantity every time a detection timing arrives, the physical quantity being related to an operating state of a motor, and the motor being provided in the electric work machine;
obtaining a variation every time the detection timing arrives, the variation corresponding to an increased amount of the physical quantity from that obtained at the detection timing of last time to that obtained at the detection timing of this time;
calculating a sum value every time the detection timing arrives, the sum value corresponding to a sum of one or more variations, and each of the one or more variations corresponding to the variation obtained at the corresponding detection timing during a first period; and
controlling the motor in accordance with a control system based on the sum value.

Such a method can exhibit similar effects to those of the electric work machine described above.

### BRIEF DESCRIPTION OF THE DRAWINGS

An example embodiment of the present disclosure will be described below with reference to the accompanying drawings, in which:

FIG. 1 is a perspective diagram of an electric work machine according to an embodiment;

FIG. 2 is a configuration diagram illustrating an electrical configuration of the electric work machine;

FIG. 3 is an explanatory diagram illustrating a first operational example of the electric work machine;

FIG. 4 is an explanatory diagram illustrating a second operational example of the electric work machine;

FIG. 5 is a flowchart of main process;

FIG. 6 is a part of a flowchart of a soft no-load return determination process;

FIG. 7 is the remaining part of the flowchart of the soft no-load return determination process; and

FIG. 8 is a flowchart of a desired rotational speed decision process.

### DETAILED DESCRIPTION OF EXEMPLARY EMBODIMENTS

### 1. Overview of Embodiment

One embodiment may provide an electric work machine including at least one of the following features 1 to 6.
Feature 1: a motor. The motor may be configured to drive a driven tool attached to the electric work machine. The driven tool may be configured to be detachably attached to the electric work machine.
Feature 2: a drive circuit configured to drive the motor.
Feature 3: a physical quantity obtainer configured to obtain a physical quantity every time a detection timing arrives. The physical quantity may be related to an operating state (or a state, or an operate state, or an operational status) of the motor.
Feature 4: a variation obtainer (or a variation calculator, or a variation deriving unit) configured to obtain (or derive, or calculate) a variation (or an amount of change) every time the detection timing arrives. The variation corresponds to an increased amount (or an increase amount, or the degree of change) of the physical quantity from that obtained at the detection timing of last time to that obtained at the detection timing of this time.
Feature 5: a sum calculator configured to calculate a sum value (or a cumulative sum) every time the detection timing arrives. The sum value corresponds to a sum of one or more variations. Each of the one or more variations corresponds to the variation obtained at the corresponding detection timing during a first period. The first period may be from a first calculation start timing to the detection timing of this time.
Feature 6: a drive controller configured to control the motor in accordance with a first control system via the drive circuit based on the sum value calculated by the sum calculator having satisfied or satisfying a no-load detection requirement. The no-load detection requirement is required to detect no application of a load to the motor (in other word, to detect that no load is applied to the motor).

The electric work machine may include a control circuit. The control circuit may include at least one of the physical quantity obtainer (that is, feature 3), the variation obtainer (that is, feature 4), the sum calculator (that is, feature 5), and the drive controller (that is, feature 6).

The drive circuit may drive the motor by supplying electric power to the motor. The detection timing may be periodically or aperiodically repeated.

The driven tool may be attached to the electric work machine, or may be configured to be detachably attached to the electric work machine. The electric work machine may include a transmission mechanism (or a rotational force transmitter). The transmission mechanism may be configured to transmit a rotational force of the motor to the driven tool.

In the following description, the state where the load is not applied to the motor is referred to as “no-load state”, and the state where the load is applied to the motor is referred to as “load state”. The no-load state includes a state where the magnitude of the load applied to the motor is zero. In this case, the load state may include a state where the magnitude of the load applied to the motor is larger than zero. The no-load state may include a state where the magnitude of the load applied to the motor is less than or equal to a predetermined magnitude. In this case, the load state may include a state where the magnitude of the load applied to the motor is larger than the predetermined magnitude.

The sum value satisfying the no-load detection requirement may correspond to the motor being in the no-load state. The sum value not satisfying the no-load detection requirement may correspond to the motor being in the load state.

The load may be applied to the motor from an object to be worked outside the electric work machine via the driven tool. The no-load state may include a state where the driven tool is not in contact with an object (for example, an object to be worked) outside the electric work machine. The no-load state may include a state where (i) the driven tool is in contact with the object and (ii) the load with the predetermined magnitude or less is applied to the motor via the object.

In a case where the current physical quantity is larger than the previous physical quantity, the variation (that is, the increased amount) may be positive. In a case where the current physical quantity is smaller than the previous physical quantity, the variation may be negative. The variation may be, for example, a value (that is, a subtraction value) obtained by subtracting the previous physical quantity from the current physical quantity. That is, the variation may be the difference between the previous physical quantity and the current physical quantity.

The variation may be a quantity indicating a level of the subtraction value. Specifically, for example, in a case where (i) the subtraction value (or the variation) is positive and (ii) the absolute value of the subtraction value is less than a predetermined value al, the variation may be obtained as “+A” (“A” is a natural number). For example, in a case where (i) the subtraction value (or the variation) is positive and (ii) the absolute value of the subtraction value is greater than or equal to al, the variation may be obtained as “+2·A” (that is, twice+A). For example, in a case where (i) the subtraction value (or the variation) is negative and (ii) the absolute value of the subtraction value is less than al, the variation may be obtained as “−A”. For example, in a case where (i) the subtraction value (or the variation) is negative and (ii) the absolute value of the subtraction value is greater than or equal to al, the variation may be obtained as “−2·A” (that is, twice −A).

A value (or quantity) indicating the tendency (that is, increase or decrease) of a varying in the physical quantity may be obtained as the variation. Specifically, for example, in a case where the physical quantity increases, the variation may be obtained as “+A”. For example, in a case where the physical quantity decreases, the variation may be obtained as “−A”. In the present specification, “amount (or quantity)” is a concept including “value”.

The first calculation start timing may be determined in any manner. For example, the first calculation start timing may be a predetermined timing after the load state of the motor is determined. For example, the first calculation start timing may be a predetermined timing (i) after the load state of the motor is determined and (ii) after a desired arrival timing to be described later.

In the electric work machine including at least features 1 to 6, the no-load state of the motor is detected on the basis of the sum value. Therefore, the no-load state (or the varying from the load state to the no-load state) can be accurately detected. The motor can be controlled on the basis of the first control system at an appropriate timing based on the load.

One embodiment may include at least one of the following features 7 to 10 in addition to or in place of at least one of features 1 to 6 described above.
Feature 7: at least one switch configured to be manually operated (or manually moved) by a user of the electric work machine.
Feature 8: a target setter configured to set a desired rotational speed (or a target rotational speed) of the motor based on a state of the at least one switch. The control circuit may include the target setter.
Feature 9: the drive controller is configured to control the motor in accordance with a second control system based on the sum value not satisfying the no-load detection requirement. The second control system is different from the first control system.
Feature 10: the second control system includes controlling the motor so as to rotate the motor at the desired rotational speed set by the target setter.

In the electric work machine including at least features 1 to 10, in each of a case where the motor is in the load state and a case where the motor is in the no-load state, the motor can be appropriately controlled.

One embodiment may include the following feature 11 in addition to or in place of at least one of features 1 to 10 described above.
Feature 11: the sum calculator is configured to exclude the variation, obtained by the variation obtainer during a second period, from calculation of the sum value based on the desired rotational speed being changed (or varied) by the at least one switch. The second period corresponds to a time period from a shift timing to a predetermined timing. The shift timing corresponds to a timing when the desired rotational speed is changed.

The physical quantity may fluctuate in response to a change in the desired rotational speed. Therefore, in a case where the desired rotational speed is changed, the no-load detection requirement may be satisfied even though the motor is not in the no-load state. That is, there is a possibility that the motor is erroneously determined to be in the no-load state although the motor is not in the no-load state, and the control system of the motor is switched to the first control system.

In the electric work machine including at least features 1 to 11, in a case where the desired rotational speed is changed, the variation obtained during the second period is not included in the sum value. As a result, the erroneous detection of the no-load state is inhibited.

The physical quantity obtainer and/or the variation obtainer may stop operation during the second period. In a case where the physical quantity obtainer stops operation during the second period, the variation obtainer may not obtain the variation or may set the variation to a specified amount (for example, zero) at the first detection timing after the second period elapses.

One embodiment may include at least one of the following features 12 and 13 in addition to or in place of at least one of features 1 to 11 described above.
Feature 12: the sum calculator is configured to switch beginning of the first period from the first calculation start timing to a second calculation start timing based on the desired rotational speed being changed (or varied) by the at least one switch.
Feature 13: the second calculation start timing corresponds to the predetermined timing (that is, an end of the second period).

In the electric work machine including at least features 1 to 13, the no-load detection requirement is determined on the basis of the sum value of the variations from the second calculation start timing. Therefore, the variation during the second period can be easily excluded from the calculation of the sum value.

One embodiment may include at least one of the following features 14 to 16 in addition to or in place of at least one of features 1 to 13 described above.
Feature 14: a controlled rotational speed setter configured to (i) set a controlled rotational speed (or a controlled desired rotational speed, or actual desired rotational speed) based on the desired rotational speed, and (ii) gradually change (or vary), based on the desired rotational speed being changed (or varied), the controlled rotational speed to the desired rotational speed changed. The controlled rotational speed setter may be included in the control circuit.
Feature 15: the second control system includes controlling the motor so that an actual rotational speed of the motor is consistent with (or is maintained at, or matches) the controlled rotational speed.
Feature 16: the second period includes a desired arrival period (or a target arrival period). The desired arrival period corresponds to a time period from the shift timing to a desired arrival timing (or a target arrival timing). The desired arrival timing corresponds to a timing when the controlled rotational speed has reached to the desired rotational speed by the controlled rotational speed setter.

Basically, the controlled rotational speed setter may match the controlled rotational speed with the desired rotational speed. In a case where the desired rotational speed is changed, the controlled rotational speed setter does not immediately change the controlled rotational speed to the desired rotational speed. In a case where the desired rotational speed is changed, the controlled rotational speed setter gradually brings the controlled rotational speed close to the desired rotational speed. Specifically, the controlled rotational speed setter may monotonically increase or monotonically decrease the controlled rotational speed to the desired rotational speed, for example.

In the electric work machine including at least features 1 to 11 and 14 to 16, the influence of the fluctuation in the physical quantity due to shifting can be efficiently excluded from the sum value.

One embodiment may include the following feature 17 in addition to or in place of at least one of features 1 to 16 described above.
Feature 17: the second period further includes a time period from the desired arrival timing until a standby time (or a first time) elapses.

In the electric work machine including at least features 1 to 11 and 14 to 17, the influence of the fluctuation in the physical quantity due to shifting can be more efficiently excluded from the sum value. Specifically, for example, it is possible to exclude or inhibit so-called overshoot or undershoot of the actual rotational speed of the motor after the desired arrival timing from affecting the sum value. For example, it is possible to exclude or inhibit lowering of the reliability of the sum value.

One embodiment may include at least one of the following features 18 and 19 in addition to or in place of at least one of features 1 to 17 described above.
Feature 18: the sum calculator is configured to, in the first period, accumulate the variation every time the detection timing arrives to thereby calculate the sum value.
Feature 19: the sum calculator is configured to reset (or initialize) the sum value currently calculated based on (i) the at least one switch being manually operated and (ii) to thereby the desired rotational speed being changed (or varied).

In the electric work machine including at least features 1 to 11, 18, and 19, in a case where the desired rotational speed is changed, the sum value accumulated so far is reset, and the variation during the second period is excluded from the calculation of the sum value. In other words, the state where the sum value is reset is maintained until the second period elapses. As a result, the erroneous detection of the no-load state is inhibited. Resetting the sum value may include any aspect. Resetting the sum value may include, for example, changing the sum value to zero or a predetermined initial value.

One embodiment may include the following features 20 and/or 21 in addition to or in place of at least one of features 1 to 19 described above.
Feature 20: the at least one switch includes a first switch.
Feature 21: the target setter is configured to change the desired rotational speed based on a position of the first switch.

In the electric work machine including at least features 1 to 11, 20, and 21, it is possible to improve the workability of the user in a case where the motor is in the load state.

One embodiment may include the following features 22 and/or 23 in addition to or in place of at least one of features 1 to 21 described above.
Feature 22: the at least one switch includes a second switch.
Feature 23: the target setter is configured to change the desired rotational speed with a maximum rotational speed as an upper limit. The maximum rotational speed is determined based on a position of the second switch.

The second switch is used to set the maximum rotational speed. The desired rotational speed is set with the maximum rotational speed set by the second switch as an upper limit. For example, in a case where the first switch is not provided, the desired rotational speed may be set to the maximum rotational speed set by the second switch. For example, in a case where the first switch is provided, the desired rotational speed may gradually increase to the maximum rotational speed in response to the movement of the first switch.

In the electric work machine including at least features 1 to 11, and 20 to 23, it is possible to further improve the workability of the user in a case where the motor is in the load state.

One embodiment may include the following features 24 or 25 in addition to or in place of at least one of features 1 to 23 described above.
Feature 24: the no-load detection requirement is satisfied based on the sum value calculated by the sum calculator having a predetermined magnitude. The predetermined magnitude corresponds to a magnitude less than or equal to a predetermined threshold.
Feature 25: the no-load detection requirement is satisfied based on the sum value calculated by the sum calculator having a predetermined magnitude. The predetermined magnitude corresponds to a magnitude greater than or equal to a predetermined threshold.

In the electric work machine including at least features 1 to 6 and 24 and the electric work machine including at least features 1 to 6 and 25, it is possible to easily determine that the motor is in the no-load state. For example, it is assumed that the physical quantity decreases as the load decreases (that is, the physical quantity has such a property). An example of such a physical quantity may be an electric current flowing through the motor. In this case, by providing feature 24, it is possible to easily determine that the motor is in the no-load state. In addition, for example, it is assumed that the physical quantity increases as the load decreases (that is, the physical quantity has such a property). An example of such a physical quantity may be an actual rotational speed of the motor. In this case, by providing feature 25, it is possible to easily determine that the motor is in the no-load state.

One embodiment may include the following feature 26 in addition to or in place of at least one of features 1 to 25 described above.
Feature 26: the no-load detection requirement is satisfied based on the sum value calculated by the sum calculator continuing to maintain the predetermined magnitude for a determination time.

In the electric work machine including at least features 1 to 6, 24, and 26 and the electric work machine including at least features 1 to 6, 25, and 26, it is possible to easily and accurately determine that the motor is in the no-load state.

One embodiment may include the following feature 27 in addition to or in place of at least one of features 1 to 26 described above.
Feature 27: the first control system includes rotating the motor at a first rotational speed. The first rotational speed is constant (or fixed).

In the electric work machine including at least features 1 to 6 and 27, it is possible to stabilize the rotation state of the motor in a case where the motor is in the no-load state.

One embodiment may include feature 27 described above and the following feature 28 in addition to or in place of at least one of features 1 to 26 described above.
Feature 28: the first rotational speed is lower than the desired rotational speed. The desired rotational speed may be based on a state of the at least one switch.

In the electric work machine including at least features 1 to 6, 27, and 28, it is possible to stabilize the rotation state of the motor in a case where the motor is in the no-load state, and it is possible to improve the workability in a case where the motor transitions from the no-load state to the load state.

One embodiment may include the following feature 29 in addition to or in place of at least one of features 1 to 28 described above.
Feature 29: the physical quantity includes an electric current (or a magnitude of an electric current, or a value of an electric current) flowing through the motor.

In the electric work machine including at least features 1 to 6 and 29, it is possible to easily and accurately determine that the motor is in the no-load state.

The physical quantity obtainer may obtain any physical quantity that varies depending on the magnitude of the load. The physical quantity may be, for example, an actual rotational speed of the motor. The physical quantity may be, for example, a voltage applied to the motor or a value indirectly indicating the voltage.

One embodiment may provide a method of controlling a motor in an electric work machine, the method including at least one of the following features 30 to 33.
Feature 30: obtaining a physical quantity every time a detection timing arrives. The physical quantity is related to an operating state of a motor. The motor is provided in the electric work machine.
Feature 31: obtaining (or deriving, or calculating) a variation every time the detection timing arrives. The variation corresponds to an increased amount (or an increase amount) of the physical quantity from that obtained at the detection timing of last time to that obtained at the detection timing of this time.
Feature 32: calculating a sum value (or a cumulative sum) every time the detection timing arrives. The sum value corresponds to a sum of one or more variations. Each of the one or more variations corresponds to the variation obtained at the corresponding detection timing during a first period.
Feature 33: controlling the motor in accordance with a control system based on the sum value.

By using the method including features 30 to 33 in the electric work machine, it is possible to accurately detect that the motor is in the no-load state (or that the motor has varied from the load state to the no-load state).

In one embodiment, features 1 to 33 described above may be combined in any way.

In one embodiment, any of features 1 to 33 described above may be excluded.

Examples of the electric work machine include various electric tools used in work sites such as DIY, manufacturing, gardening, and construction sites, specifically, electric tools for masonry, metalworking, woodworking, and gardening and electric tools for preparing a worksite environment, and more specifically, an electric jigsaw, an electric reciprocating saw, an electric chain saw, an electric grinder, an electric circular saw, an electric cutter, an electric hedge-trimmer, an electric lawn mower, an electric lawn clipper, an electric brush cutter, an electric driver, an electric screwdriver, an electric drill, an electric hammer, an electric hammer drill, an electric wrench, an electric canner, an electric nail driver (including a rivet), and the like.

The electric work machine may receive electric power for driving the motor in any manner. The electric work machine may include, for example, a battery, or may be configured in a manner that a battery pack including the battery is detachable. In this case, the electric work machine may be configured to receive electric power from the battery.

In one embodiment, the control circuit may be integrated into a single electronic unit or into a single electronic device or into a single circuit board.

In one embodiment, the control circuit may be two or more electronic circuits or two or more electronic units or a combination of two or more electronic devices individually provided in the electric work machine.

In one embodiment, the control circuit may include a microcomputer (or a microcontroller or a microprocessor), wired logic, an application specific integrated circuit (ASIC), an application specific general purpose (ASSP), a programmable logic device (such as a field programmable gate array (FPGA)), discrete electronic components, and/or combinations thereof.

### 2. Specific Exemplary Embodiment

An exemplary embodiment of the present disclosure will be described below.

### (2-1) Outline of Electric Work Machine

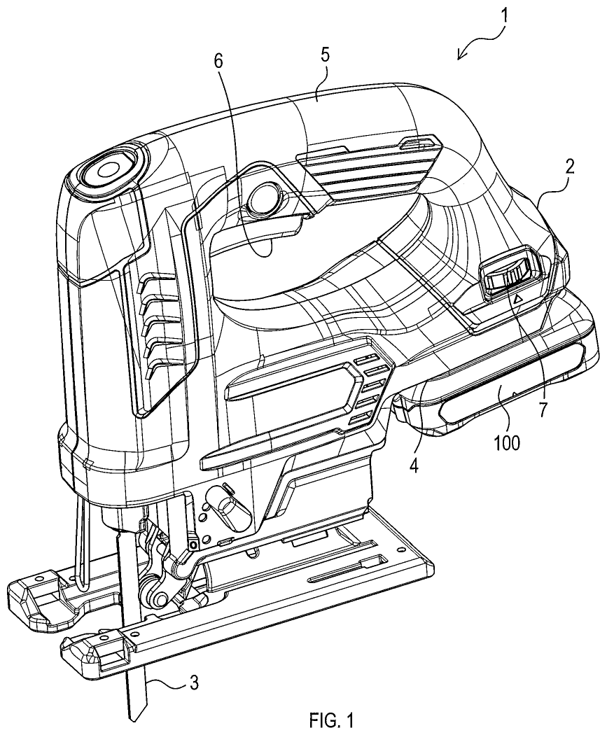

As illustrated in FIG. 1, an electric work machine 1 according to the present embodiment is in the form of a jigsaw. The electric work machine 1 includes a housing 2. The housing 2 supports a driven tool 3. The driven tool 3 is detachably attached to the housing 2. FIG. 1 illustrates the electric work machine 1 to which the driven tool 3 is attached. The driven tool 3 is in the form of a saw blade (that is, a jigsaw blade). The driven tool 3 is supported to be able to reciprocate.

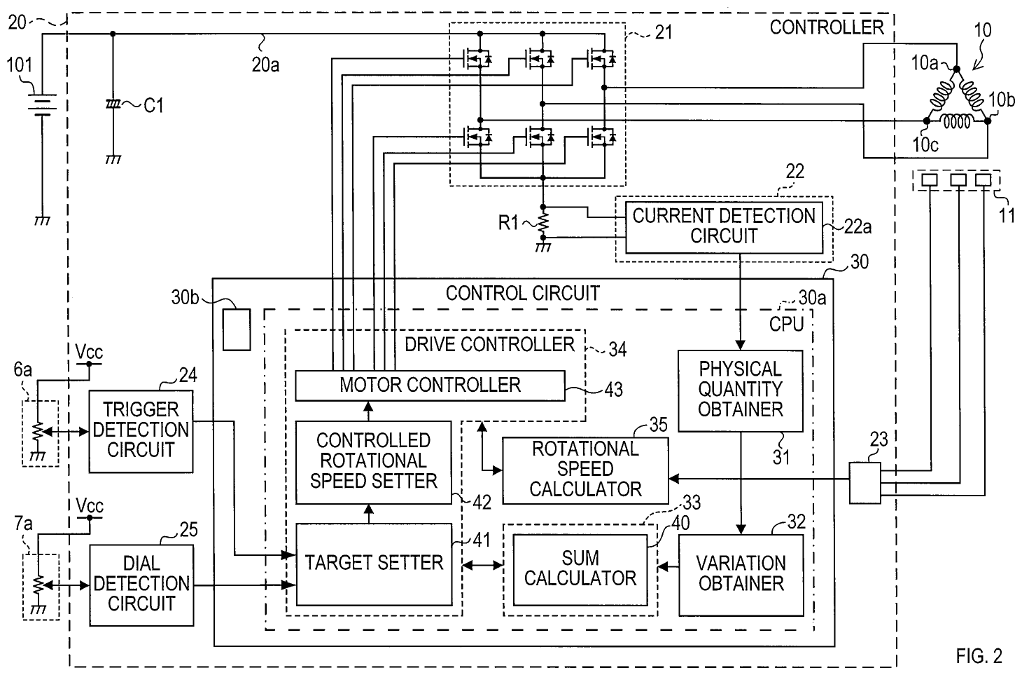

The housing 2 houses a motor 10 and various circuits (see FIG. 2) to be described later. The housing 2 houses a transmission mechanism (not illustrated).

The motor 10 is mechanically coupled to the driven tool 3 via the transmission mechanism. The transmission mechanism transmits the rotation of the motor 10 to the driven tool 3. The rotational force of the motor 10 is transmitted to the driven tool 3 via the transmission mechanism, thereby driving (i.e., reciprocating) the driven tool 3. The reciprocating speed of the driven tool 3 varies depending on the rotational speed of the motor 10. As the rotational speed of the motor 10 increases, the speed of the driven tool 3 increases accordingly, and as the rotational speed of the motor 10 decreases, the speed of the driven tool 3 decreases accordingly.

The electric work machine 1 includes a battery pack 100. The housing 2 includes an attachment portion 4. The battery pack 100 is detachably attached to the attachment portion 4. FIG. 1 illustrates a state where the battery pack 100 is attached to the attachment portion 4. The battery pack 100 includes a repeatedly chargeable battery 101 (see FIG. 2). The battery 101 includes two or more battery cells. The battery 101 may be, for example, a lithium ion battery.

The housing 2 includes a grip 5. The grip 5 is gripped by a user of the electric work machine 1.

The housing 2 includes a trigger (or first switch) 6. The trigger 6 is manually moved (for example, pulled) by the user. The trigger 6 is at the initial position if not manually moved (that is, not pulled) by the user. When pulled from the initial position, the trigger 6 is moved from the initial position. When the trigger 6 is pulled, the motor 10 is driven to drive the driven tool 3. The user can use the electric work machine 1 by pulling the trigger 6 while gripping the grip 5. Specifically, the user can cut a workpiece (for example, wood, metal, a resin member, and the like) with the driven tool 3.

The housing 2 includes a speed adjustment dial (or second switch) 7. The speed adjustment dial 7 is manually moved by the user to set the maximum value (that is, the maximum rotational speed) of the rotational speed of the motor 10. The speed adjustment dial 7 of the present embodiment is rotated by the user. The user can select one of a plurality of types of maximum rotational speeds using the speed adjustment dial 7.

In the present embodiment, as will be described later, the motor 10 is controlled in accordance with a first control system or a second control system. The first control system is a control system of controlling the motor 10 in accordance with soft no-load control. In the following description, executing the soft no-load control is synonymous with controlling the motor 10 by the first control system.

The soft no-load control is executed when the motor 10 is in a no-load state. The no-load state corresponds to a state where no load is applied to the motor 10. In the present embodiment, the load is directly applied to the driven tool 3. The load is applied to the motor 10 via the driven tool 3. The no-load state may be only a state where no load is applied, or may include a state where a load with a certain magnitude or less is applied. The certain magnitude is larger than zero.

In the soft no-load control, the motor 10 is controlled in a manner that the motor 10 rotates at a first rotational speed regardless of the pulling amount (or the movement amount) of the trigger 6 and the position of the speed adjustment dial 7 (that is, the set maximum rotational speed). The first rotational speed is fixed. The pulling amount or the movement amount of the trigger 6 may be the amount of pulling or the amount of movement from the initial position. The pulling amount or the movement amount of the trigger 6 may be the amount of pulling or the amount of movement from the reference position. The reference position may be the same as the initial position, or may be a position moved (that is, pulled) by a certain amount from the initial position.

The second control system is executed when the motor 10 is in a load state. The load state corresponds to a state where a load is applied to the motor 10. The load state may be a state where a load larger than zero is applied, or may be a state where a load larger than the certain magnitude is applied.

In the second control system, the soft no-load control is released, and the motor 10 is controlled without using the soft no-load control. Specifically, in the second control system, the desired rotational speed is set based on the pulling amount of the trigger 6 and the position of the speed adjustment dial 7. The motor 10 is controlled to rotate at the set desired rotational speed (specifically, at a controlled rotational speed to be described later). In other words, in the second control system, the motor 10 is controlled in a manner that the actual rotational speed of the motor 10 is consistent with (or matches) the controlled rotational speed.

### (2-2) Electrical Configuration of Electric Work Machine

As illustrated in FIG. 2, the electric work machine 1 includes the motor 10 and a controller 20. The controller 20 controls the rotation of the motor 10 and thus the reciprocating movement of the driven tool 3. FIG. 2 electrically illustrates the electric work machine 1 to which the battery pack 100 is attached. When the battery pack 100 is attached to the electric work machine 1, the battery 101 is electrically coupled to the controller 20.

The motor 10 of the present embodiment is in the form of a three-phase brushless motor. The motor 10 includes a first terminal 10a, a second terminal 10b, and a third terminal 10c. The motor 10 receives a three-phase electric power via the first to third terminals 10a to 10c to thereby rotate. The motor 10 includes three windings corresponding to three phases, respectively. In the present embodiment, the three windings are, for example, delta-connected to each other.

The electric work machine 1 includes a rotation sensor 11. The rotation sensor 11 includes three Hall ICs. The three Hall ICs are arranged at a specified angle from each other along the rotational direction of the motor 10 (specifically, the rotational direction of a rotor). The specified angle is an angle corresponding to an electrical angle of 120 degrees. Each of the three Hall ICs outputs a rotation detection signal corresponding to the position of the Hall IC and the rotational position of the rotor. The rotation detection signal is, for example, in the form of a pulse signal. The three rotation detection signals from the rotation sensor 11 are input to the controller 20.

The electric work machine 1 includes a first detector 6a. The first detector 6a detects that the trigger 6 has been moved and the movement amount of the trigger 6. When the trigger 6 is pulled, the first detector 6a outputs a trigger-on detection signal indicating that the trigger 6 is pulled. The first detector 6a further outputs a first detection signal indicating the position (that is, the pulling amount or the movement amount) of the trigger 6. The first detector 6a includes a variable resistor. The resistance value of the variable resistor changes in conjunction with the movement of the trigger 6. The first detector 6a outputs a first detection signal corresponding to the resistance value of the variable resistor. The trigger-on detection signal and the first detection signal are input to the controller 20.

The electric work machine 1 includes a second detector 7a. The second detector 7a detects the position of the speed adjustment dial 7. The second detector 7a outputs a second detection signal indicating the position of the speed adjustment dial 7. The second detection signal is input to the controller 20.

The controller 20 can (i) recognize that the trigger 6 has been pulled on the basis of the trigger-on detection signal, (ii) recognize the position of the trigger 6 on the basis of the first detection signal, and (iii) recognize the position of the speed adjustment dial 7 on the basis of the second detection signal.

The controller 20 includes a drive circuit 21 and a power supply line 20a. The power supply line 20a electrically couples the drive circuit 21 to the positive electrode of the battery 101. The drive circuit 21 is further electrically coupled to the ground. The drive circuit 21 is coupled to the negative electrode of the battery 101 via the ground.

The drive circuit 21 is coupled to the motor 10. More specifically, the drive circuit 21 is coupled to the first to third terminals 10a to 10c. The drive circuit 21 (i) receives a battery power from the battery 101, (ii) converts the battery power into the three-phase electric power, and (iii) derives the three-phase electric power to the motor 10 via the first to third terminals 10a to 10c.

The drive circuit 21 of the present embodiment is in the form of a so-called three-phase full bridge circuit. That is, the drive circuit 21 includes three positive paths and three negative paths. The three positive paths respectively connect the first to third terminals 10a to 10c to the power supply line 20a. The three negative paths electrically couple the first to third terminals 10a to 10c to the ground, respectively. The drive circuit 21 includes three high-side switches and three low-side switches. The three high-side switches are on the three positive paths, respectively. Each of the three high-side switches completes or interrupts the corresponding positive path. The three low-side switches are on the three negative paths, respectively. Each of the three low-side switches completes or interrupts the corresponding negative path. In the present embodiment, each of the three high-side switches and each of the three low-side switches is in the form of a semiconductor switching element.

The controller 20 includes a ground connection path. The ground connection path electrically couples the drive circuit 21 to the ground. The ground connection path includes (i) a first end connected to the drive circuit 21 (specifically, connected to each of the three negative paths), and (ii) a second end connected to the ground. The controller 20 includes a resistor R1 on the ground connection path. An electric current from the drive circuit 21 to the ground flows through the resistor R1.

The controller 20 includes a physical-quantity detection circuit 22. The physical-quantity detection circuit 22 detects a physical quantity related to the operating state of the motor 10. The physical-quantity detection circuit 22 of the present embodiment detects a motor current as an example. The motor current corresponds to an electric current supplied from the battery 101 to the motor 10. Specifically, the physical-quantity detection circuit 22 includes a current detection circuit 22a. Both ends of the resistor R1 are connected to the current detection circuit 22a. The current detection circuit 22a outputs a current detection signal corresponding to the magnitude of the voltage across the resistor R1. The current detection signal indicates the magnitude of the current flowing through the resistor R1 The motor current supplied from the battery 101 to the motor 10 flows through the resistor R1. Therefore, the current detection signal indicates the magnitude of the motor current. The physical-quantity detection circuit 22 outputs a physical-quantity detection signal indicating the detected physical quantity. In the present embodiment, the physical-quantity detection signal includes the current detection signal. The physical-quantity detection signal is input to a control circuit 30.

The controller 20 includes a capacitor C1. The capacitor C1 is coupled between the power supply line 20a and the ground. The capacitor C1 smooths the battery power supplied to the drive circuit 21.

The controller 20 includes a position detection circuit 23. The position detection circuit 23 receives three rotation detection signals from the rotation sensor 11. The position detection circuit 23 detects the rotational position of the motor 10 (specifically, the rotor) on the basis of the three rotation detection signals. The position detection circuit 23 outputs a position signal corresponding to the detected rotational position.

The controller 20 includes a trigger detection circuit 24. The trigger detection circuit 24 receives a trigger-on detection signal and a first detection signal from the first detector 6a. The trigger detection circuit 24 outputs a trigger-on signal while receiving the trigger-on detection signal (that is, while the trigger 6 is pulled). The trigger-on signal indicates that the trigger 6 is pulled. The trigger detection circuit 24 further outputs a first command signal on the basis of the first detection signal. The first command signal indicates the pulling amount of the trigger 6.

The controller 20 includes a dial detection circuit 25. The dial detection circuit 25 receives a second detection signal from the second detector 7a. The dial detection circuit 25 outputs a second command signal on the basis of the second detection signal. The second command signal indicates the position of the speed adjustment dial 7. In other words, the second command signal indicates the maximum rotational speed selected by the speed adjustment dial 7.

The controller 20 includes the control circuit 30. The control circuit 30 controls the motor 10 via the drive circuit 21. In the present embodiment, the control circuit 30 is in the form of a microcomputer or a micro control unit (MCU) including a CPU30a, a memory 30b, and the like. The memory 30b includes, a semiconductor memory such as a ROM and a RAM.

Various functions of the control circuit 30 are achieved by the CPU30a executing a program stored in the memory 30b. By executing the program, the method corresponding to the program is executed. The memory 30b corresponds to an example of a non-transitory tangible recording medium storing a program.

The memory 30b stores a motor control program for controlling the motor 10 (directly controlling the drive circuit 21). The CPU30a executes the motor control program, thereby functioning as a physical quantity obtainer 31, a variation obtainer 32 (or a variation calculator 32, or a variation deriving unit 32), a soft no-load determiner 33, a drive controller 34, and a rotational speed calculator 35 illustrated in FIG. 2. That is, the substance of the physical quantity obtainer 31, the variation obtainer 32, the soft no-load determiner 33, the drive controller 34, and the rotational speed calculator 35 is a function achieved by software.

In other embodiments, some or all of the functions executed by the CPU30a may be achieved by one or more electronic components, such as discrete elements and integrated circuits (ICs). In still other embodiments, the control circuit 30 may include one or more additional microcomputers or one or more additional MCUs. In still other embodiments, the control circuit 30 may be in the form of a hardwired circuit. Specifically, the control circuit 30 may include a logic circuit (alternatively, a wired logic connection) including two or more electronic components. In still other embodiments, the control circuit 30 may include an ASIC and/or an ASSP. In still other embodiments, the control circuit 30 may include a programmable logic device on which a reconstructable logic circuit may be constructed. Examples of the programmable logic device include an FPGA.

The control circuit 30 receives the physical-quantity detection signal from the physical-quantity detection circuit 22. The control circuit 30 receives the position signal from the position detection circuit 23. The control circuit 30 receives the trigger-on signal from the trigger detection circuit 24. The control circuit 30 receives a first command signal from the trigger detection circuit 24. The control circuit 30 receives a second command signal from the dial detection circuit 25. The control circuit 30 controls the drive circuit 21 (eventually, controls the motor 10) on the basis of the physical-quantity detection signal, the position signal, the trigger-on signal, the first command signal, and/or the second command signal.

The control circuit 30 stops the motor 10 while the control circuit 30 does not receive the trigger-on signal. When receiving the trigger-on signal, the control circuit 30 drives the motor 10. At this time, the control circuit 30 (i) sets the desired rotational speed on the basis of the first command signal and the second command signal, and (ii) controls the motor 10 based on the desired rotational speed.

The rotational speed calculator 35 calculates the actual rotational speed of the motor 10 on the basis of the position signal.

The physical quantity obtainer 31 obtains the physical quantity on the basis of the physical-quantity detection signal every time the detection timing arrives. As described above, the physical-quantity detection signal of the present embodiment includes the current detection signal. The physical quantity obtainer 31 obtains the magnitude of the motor current (hereinafter, referred to as “motor current value”) on the basis of the current detection signal. Therefore, the physical quantity obtainer 31 may be referred to as “current value obtainer 31”. In the present embodiment, the detection timing arrives repeatedly at a predetermined acquisition cycle. The acquisition cycle of the present embodiment matches a control cycle to be described later.

The variation obtainer 32 obtains (or derives, or calculates) the variation of the physical quantity every time the detection timing arrives. The variation corresponds to an increased amount (or an increase amount, or the degree of change) from the previous value to the current value. The previous value is the physical quantity obtained by the physical quantity obtainer 31 at the previous detection timing (that is, the detection timing in the acquisition cycle immediately before that of the current detection timing). The current value is the physical quantity obtained by the physical quantity obtainer 31 at the current detection timing. The physical quantity obtainer 31 of the present embodiment obtains at least a motor current value. The variation obtainer 32 of the present embodiment thus obtains the variation of the motor current value. Therefore, in the following description, the variation is referred to as “electric current variation”.

For example, the variation obtainer 32 may obtain the electric current variation by subtracting the previous value from the current value. That is, the electric current variation may be the difference between the previous value and the current value. In other words, the electric current variation may indicate how much the current value has varied (increased or decreased) from the previous value. Therefore, the electric current variation can be positive or negative.

Alternatively, the variation obtainer 32 may convert the increased amount from the previous value to the current value into a discrete numerical value, and obtain the converted numerical value as the electric current variation. Specifically, the electric current variation may be set to “0” in a case where the absolute value of the increased amount from the previous value to the current value is less than a predetermined reference value Io. The electric current variation may be set to “+1” when (i) the current value increases from the previous value and (ii) the increased amount is greater than or equal to the reference value Io. The electric current variation may be set to “+2” when (i) the current value increases from the previous value and (ii) the increased amount is twice or more the reference value Io. The electric current variation may be set to “−1” when (i) the current value decreases from the previous value and (ii) the decrease amount is greater than or equal to the reference value Io. The electric current variation may be set to “−2” when (i) the current value decreases from the previous value and (ii) the decrease amount is twice or more the reference value Io.

The soft no-load determiner 33 determines whether the motor 10 is in the no-load state or in the load state, and generates a predetermined command on the basis of the determination result. Specifically, the soft no-load determiner 33 sets or clears a soft no-load release determination flag on the basis of the determination result.

At the start of drive of the motor 10, the soft no-load determiner 33 determines that the motor 10 is in the no-load state. The soft no-load determiner 33 decides (or determines) to execute (or activate) the soft no-load control on the basis of the determination that the motor 10 is in the no-load state. The execution decision (or the activation decision) includes deciding (or determining) that the soft no-load control should be executed. The execution decision includes commanding the drive controller 34 to execute the soft no-load control. The execution decision includes clearing the soft no-load release determination flag.

The soft no-load determiner 33 decides (or determines) to release (or deactivate) the soft no-load control on the basis of the determination of the variation from the no-load state to the load state. The release decision (or the deactivation decision) includes deciding (or determining) that the soft no-load control should be released. The release decision includes commanding the drive controller 34 to stop the soft no-load control. The release decision includes setting the soft no-load release determination flag.

Whether or not the motor 10 is in the load state may be determined by any method. For example, it may be determined that the motor 10 is in the load state on the basis of the fact that the motor current value exceeds a current threshold. Alternatively, the determination may be performed using the load state detection method described in Patent Literature 1.

The soft no-load determiner 33 decides to execute the soft no-load control on the basis of the determination that the state of the motor 10 has varied from the load state to the no-load state.

In order to determine whether or not the motor 10 is in the no-load state, the soft no-load determiner 33 of the present embodiment includes a sum calculator 40. The sum calculator 40 calculates the sum value every time the detection timing arrives. The sum value corresponds to the sum of the electric current variations obtained by the variation obtainer 32 during a first period. The first period corresponds to a time period from a first calculation start timing to the detection timing of this time (that is, to the detection timing having arrived most recently). The sum value includes the electric current variation at the detection timing of this time.

The sum calculator 40 may calculate the sum value by any method. In the present embodiment, the sum calculator 40 accumulates (that is, cumulatively adds) the electric current variation every time the detection timing arrives within the first period, thereby calculating the sum value.

The first calculation start timing corresponds to the beginning of the first period. The first calculation start timing may be determined in any manner. In the present embodiment, the first calculation start timing is after the load state of the motor 10 is determined and at least after a desired arrival timing. The desired arrival timing corresponds to the timing when the controlled rotational speed reaches the desired rotational speed. More specifically, the first calculation start timing of the present embodiment is the time when a first standby time has elapsed from the desired arrival timing. The time period from the desired arrival timing until the first standby time elapses is referred to as “first load stabilization period”.

The sum calculator 40 further has the following features. That is, the sum calculator 40 excludes the electric current variation in a second period from the calculation of the sum value on the basis of the fact that a shift operation has been performed. The second period corresponds to a time period from a shift timing to a predetermined timing. The shift timing corresponds to the timing when the shift operation is performed. The shift operation includes the movement of the trigger 6 and/or the speed adjustment dial 7. More specifically, the shift operation includes moving the trigger 6 and/or the speed adjustment dial 7 in a manner that the desired rotational speed is changed by a target setter 41.

The sum calculator 40 stops the accumulation of the electric current variation until the second period elapses on the basis of the fact that the shift operation has been performed. On the basis of the fact that the shift operation has been performed, the sum calculator 40 further resets (or initializes) the sum value accumulated up to the present time (that is, the shift timing). The sum calculator 40 then performs the accumulation again after the second period has elapsed. In this case, the sum calculator 40 does not need to perform the accumulation at the first detection timing after the second period has elapsed. The sum calculator 40 may start the accumulation from the second detection timing after the second period has elapsed. Alternatively, at the first detection timing after the second period has elapsed, the variation obtainer 32 may avoid obtaining the electric current variation. In other words, at the first detection timing, zero or a value close to zero may be obtained as the electric current variation.

Resetting (or initializing) the sum value may include, for example, setting the sum value to zero, or may include, for example, setting the sum value to a predetermined initial value.

The second period may be determined in any manner. In the present embodiment, the second period includes a desired arrival period and a second load stabilization period. The desired arrival period is from the shift timing (or the change of the desired rotational speed by the shift operation) to the desired arrival timing. The second load stabilization period is a time period from the desired arrival timing until the second standby time elapses.

Immediately after the controlled rotational speed reaches the desired rotational speed, the actual rotational speed of the motor 10 may fluctuate. Specifically, so-called overshoot or undershoot of the actual rotational speed may occur. The second load stabilization period is provided in consideration of such fluctuation of the actual rotational speed. The same applies to the first load stabilization period described above. Therefore, each of the first load stabilization period and the second load stabilization period may be determined in consideration of a convergence time. The convergence time corresponds to the time required for the fluctuation of the actual rotational speed to fall below a certain level. In the present embodiment, the second standby time is the same as the first standby time. The second standby time may be different from the first standby time.

The soft no-load determiner 33, on the basis of the fact that the sum calculated by the sum calculator 40 satisfies a no-load detection requirement, (i) determines that the motor 10 is in the no-load state and (ii) decides to execute the soft no-load control. As a result, the soft no-load control is executed.

The no-load detection requirement is required to detect that the motor 10 is in the no-load state. The no-load detection requirement may be determined in any manner. In the present embodiment, the no-load detection requirement is satisfied on the basis of the fact that the calculated sum value maintains the current threshold or less during a predetermined return determination time.

The drive controller 34 controls the motor 10 in accordance with the first control system or the second control system. That is, in a case where the motor 10 is in the no-load state (that is, in a case where the soft no-load control is decided to be executed), the drive controller 34 controls the motor 10 via the drive circuit 21 in accordance with the first control system (that is, using the soft no-load control). In a case where the motor 10 is in the load state (that is, in a case where the soft no-load control is decided to be released), the drive controller 34 controls the motor 10 via the drive circuit 21 in accordance with the second control system (that is, without using the soft no-load control).

The drive controller 34 includes the target setter 41. The target setter 41 sets the desired rotational speed on the basis of a first command signal and a second command signal.

For example, in a case where the pulling amount of the trigger 6 is less than or equal to a first pulling amount, the target setter 41 sets the desired rotational speed to a predetermined initial target value (for example, zero). The first pulling amount may be zero or larger than zero. In a case where the pulling amount exceeds the first pulling amount, the target setter 41 sets the desired rotational speed based on the pulling amount. Specifically, the target setter 41 sets the desired rotational speed in a manner that the desired rotational speed increases continuously or stepwise as the pulling amount increases. At this time, the target setter 41 sets the desired rotational speed with the maximum rotational speed as the upper limit. Specifically, the target setter 41 sets the desired rotational speed in a manner that the desired rotational speed reaches the maximum rotational speed when the pulling amount reaches the second pulling amount. The second pulling amount is larger than the first pulling amount. The second pulling amount may correspond to the maximum pulling amount. The second pulling amount may be less than the maximum pulling amount. The maximum pulling amount corresponds to the pulling amount in a state where the trigger 6 is pulled to the maximum. In a case where the pulling amount exceeds the second pulling amount, the target setter 41 sets the desired rotational speed to the maximum rotational speed.

In the present embodiment, the soft no-load control is mainly implemented by the target setter 41. Specifically, the target setter 41 switches the method of setting the desired rotational speed depending on whether the motor 10 is in the load state or in the no-load state. In other words, the target setter 41 switches the method of setting the desired rotational speed depending on whether the soft no-load control is decided to be executed or released. In other words, the target setter 41 switches the method of setting the desired rotational speed depending on whether the drive controller 34 is commanded to execute the soft no-load control or commanded to stop the soft no-load control by the soft no-load determiner 33.

In a case where the motor 10 is in the load state (that is, in a case where the soft no-load control is decided to be released), the target setter 41 sets the desired rotational speed of the motor 10 on the basis of the first command signal and the second command signal.

On the other hand, in a case where the motor 10 is in the no-load state (that is, in a case where the soft no-load control is decided to be executed), the target setter 41 sets the desired rotational speed to the first rotational speed (that is, maintains the first rotational speed). The first rotational speed may be determined in any manner. For example, the first rotational speed may be the same as the desired rotational speed set in a case where the trigger 6 is pulled by a predetermined pulling amount in the second control system. That is, the first rotational speed may be lower than the desired rotational speed set in the second control system in a case where the trigger 6 is pulled by more than the predetermined pulling amount.

The drive controller 34 includes a controlled rotational speed setter 42. The controlled rotational speed setter 42 sets the controlled rotational speed on the basis of the desired rotational speed set by the target setter 41. The controlled rotational speed setter 42 basically matches the controlled rotational speed with the desired rotational speed. In a case where the desired rotational speed is changed, the controlled rotational speed is also changed to a new desired rotational speed after the change.

In a case where the desired rotational speed is changed, the controlled rotational speed setter 42 does not immediately change the controlled rotational speed to a new desired rotational speed. In a case where the desired rotational speed is changed, the controlled rotational speed setter 42 gradually brings the controlled rotational speed close to the new desired rotational speed at a predetermined change rate. The controlled rotational speed setter 42 may monotonically increase or monotonically decrease the controlled rotational speed toward a new desired rotational speed, for example. The predetermined change rate may be fixed or may vary. In the present embodiment, the predetermined change rate is fixed. That is, in the present embodiment, in a case where the desired rotational speed is changed, the controlled rotational speed linearly changes toward the new desired rotational speed.

The drive controller 34 includes a motor controller 43. The motor controller 43 generates a drive command. The drive command causes the actual rotational speed of the motor 10 to be consistent with the controlled rotational speed set by the controlled rotational speed setter 42. The drive command is output to the drive circuit 21. The drive command commands each of six semiconductor switching elements in the drive circuit 21 to turn on or off. The drive circuit 21 converts the battery power into the three-phase electric power in response to the drive command.

The drive command includes a pulse width modulation (PWM) signal. The PWM signal drives a duty switch. The duty switch is one of the six semiconductor switching elements. The PWM signal has a duty ratio. The duty switch is turned on or off based on the duty ratio.

The motor controller 43 decides a semiconductor switching element to be turned on, on the basis of the position signal. At this time, the motor controller 43 also decides the duty switch. The motor controller 43 obtains the actual rotational speed calculated by the rotational speed calculator 35. The motor controller 43 calculates the duty ratio on the basis of the difference between the obtained actual rotational speed and the controlled rotational speed.

In the present embodiment, as described above, at the start of drive of the motor 10, it is determined that the motor 10 is in the no-load state, and the soft no-load control is executed. That is, at the start of drive of the motor 10, regardless of the states of the trigger 6 and the speed adjustment dial 7, the desired rotational speed is set to the first rotational speed, and the motor 10 is driven. The first rotational speed may be, for example, a specified low rotational speed corresponding to the duty ratio of 50%.

After the motor 10 starts to be driven, when it is detected that the motor 10 is in the load state, the soft no-load control is released (that is, stopped). As a result, the motor 10 is controlled by the second control system.

When it is detected that the motor 10 is in the no-load state during the control with the second control system, the soft no-load control is executed.

In the present embodiment, in a case where the pulling amount of the trigger 6 is smaller than the predetermined pulling amount, the soft no-load control is not executed, and the motor 10 is controlled by the second control system. Therefore, even immediately after the start of drive of the motor 10 or even when the motor 10 is in the no-load state, in a case where the pulling amount of the trigger 6 is smaller than the predetermined pulling amount, (i) the desired rotational speed corresponding to the maximum rotational speed based on the pulling amount and the speed adjustment dial 7 is set, and (ii) the motor 10 is driven based on the desired rotational speed.

According to the present embodiment, in the soft no-load control, feedback control is executed in a manner that the actual rotational speed is consistent with the first rotational speed. In the soft no-load control, the motor 10 may be controlled by open-loop control. In the open-loop control, the duty ratio may be set a value corresponding to the first rotational speed (for example, 50%). The open-loop control may be used in the second control system. In a case where the soft no-load control is decided to be executed, the soft no-load control may be executed regardless of the amount of pulling of the trigger 6.

### (2-3) Operational Example of Electric Work Machine

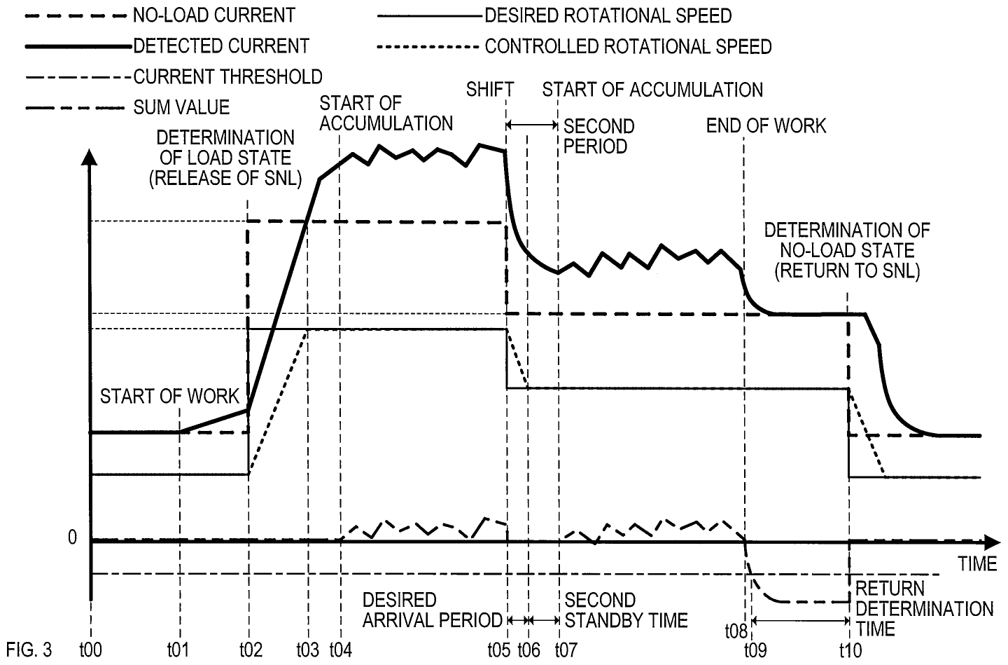

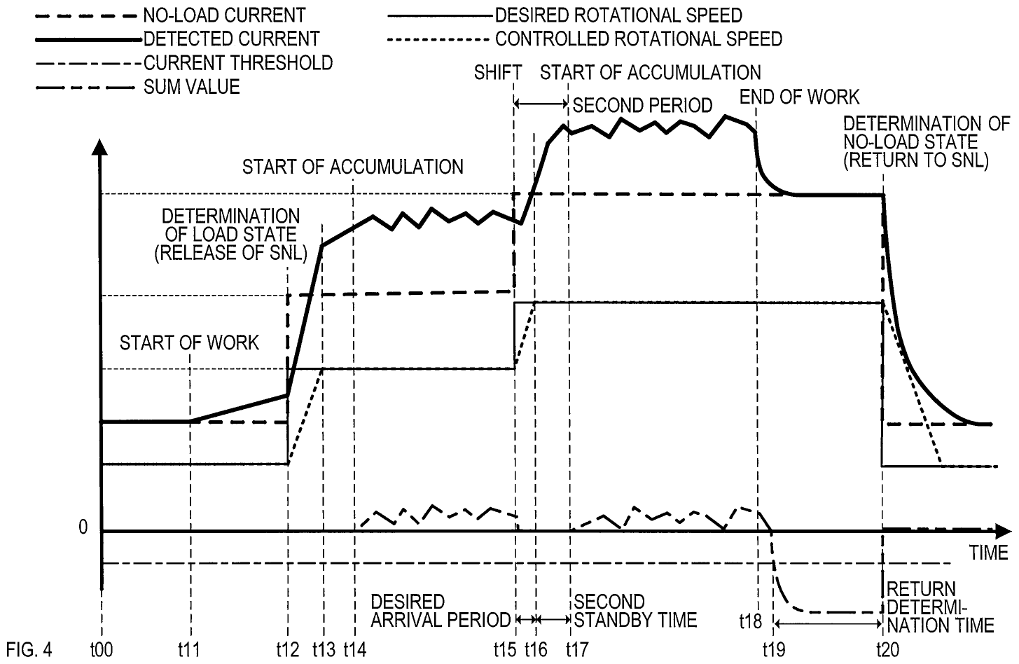

Next, an operational example of the electric work machine 1 will be described with reference to FIGS. 3 and 4. FIGS. 3 and 4 each illustrate an example in which after the start of drive of the motor 10, the motor 10 changes to the load state, and then changes to the no-load state. In FIG. 3, a shift operation of reducing the rotational speed of the motor 10 is performed during the load state. On the other hand, in FIG. 4, a shift operation of increasing the rotational speed of the motor 10 is performed during the load state.

In FIGS. 3 and 4, “no-load current” indicates a motor current in a case where the motor 10 is maintained in the no-load state. “Detected current” indicates a motor current value actually obtained by the physical quantity obtainer 31.

First, an operational example of FIG. 3 will be described. At a time t00, the trigger 6 is pulled and the motor 10 starts to be driven. As described above, at the start of drive, it is determined the motor 10 is in the no-load state, and the soft no-load control is executed. Therefore, at the start of drive, the desired rotational speed is limited to the first rotational speed.

At a time t01, the work of the driven tool 3 (for example, cutting of a workpiece) is started, so that the motor 10 changes to the load state. At the time t01, the control circuit 30 had not yet determined the load state.

At a time t02, the control circuit 30 determines the load state of the motor 10, so that the soft no-load control is released. In FIGS. 3 and 4, “SNL” means the soft no-load control. By the soft no-load control being released, the desired rotational speed changes to a speed based on a command from a user (that is, the states of the trigger 6 and the speed adjustment dial 7). The controlled rotational speed gradually increases toward a new desired rotational speed after the change. At a time t03, the controlled rotational speed reaches the desired rotational speed. The time t03 corresponds to the desired arrival timing. As the controlled rotational speed increases, the motor current value also increases.

A time t04 corresponds to a timing when the first standby time has elapsed from the time t03. At the time t04, the sum value (that is, the accumulation of the electric current variation) is started to be calculated. That is, the time t04 corresponds to the first calculation start timing (that is, the beginning of the first period). The period from the time t03 to t04 corresponds to the first load stabilization period.

At a time t05, the user performs a shift operation of reducing the rotational speed of the motor 10. As a result, the accumulation of the electric current variation is stopped. Furthermore, the currently calculated sum value is reset. The time t05 corresponds to the shift timing. At the time t05, the desired rotational speed also changes based on the shift operation. The controlled rotational speed gradually changes (or vary) (decreases in this case) toward the new desired rotational speed after the change, and reaches the desired rotational speed at a time t06. The time t06 corresponds to the desired arrival timing. The period from the time t05 to t06 corresponds to the desired arrival period.

A time t07 corresponds to a timing when the second standby time has elapsed from the time t06. The period from the time t06 to t07 corresponds to the second load stabilization period. At the time t07, the accumulation of the electric current variation (that is, the calculation of the sum value) is newly started.

At a time t08, the work of the driven tool 3 is temporarily interrupted while the trigger 6 is being pulled. That is, the driven tool 3 is separated from the workpiece. As a result, the motor 10 changes to the no-load state. At the time t08, the control circuit 30 had not yet determined the no-load state.

The motor current value largely decreases due to the change to the no-load state at the time t08. As a result, at a time t09, the sum value becomes less than or equal to the current threshold. A time t10 corresponds to a timing when a return determination time has elapsed from the time t09. At the time t10, the no-load state is determined. That is, the no-load state of the motor 10 is determined on the basis of the fact that the sum value continues to be less than or equal to the current threshold for the return determination time. As a result, the soft no-load control is executed again at the time t10.

Next, an operational example of FIG. 4 will be described. In FIG. 4, the operational example between the time t00 and time a t15 is substantially the same as the operational example between the time t00 and the time t05 in FIG. 3. Therefore, the description from the time t00 to the time t15 in FIG. 4 is omitted.

In FIG. 4, at the time t15, the user performs a shift operation of increasing the rotational speed of the motor 10. As a result, the accumulation of the electric current variation is stopped. Furthermore, the currently calculated sum value is reset. The time t15 corresponds to the shift timing. At the time t15, the desired rotational speed also changes based on the shift operation. The controlled rotational speed gradually changes (or vary) (increases in this case) toward the new desired rotational speed after the change, and reaches the desired rotational speed at a time t16. The time t16 corresponds to the desired arrival timing. The period from the time t15 to t16 corresponds to the desired arrival period.

A time t17 corresponds to a timing when the second standby time has elapsed from the time t16. The period from the time t16 to t17 corresponds to the second load stabilization period. At the time t17, the accumulation of the electric current variation (that is, the calculation of the sum value) is newly started.

At a time t18, the work of the driven tool 3 is temporarily interrupted while the trigger 6 is being pulled. That is, the driven tool 3 is separated from the workpiece. As a result, the motor 10 changes to the no-load state. At the time t18, the control circuit 30 has not yet determined the no-load state.

The motor current value largely decreases due to the change to the no-load state at the time t18. As a result, at a time t19, the sum value becomes less than or equal to the current threshold. A time t20 corresponds to a timing when the return determination time has elapsed from the time t19. At the time t20, the no-load state is determined. That is, the no-load state of the motor 10 is determined on the basis of the fact that the sum value continues to be less than or equal to the current threshold for the return determination time. As a result, the soft no-load control is executed again at the time t20.

### (2-4) Main Process

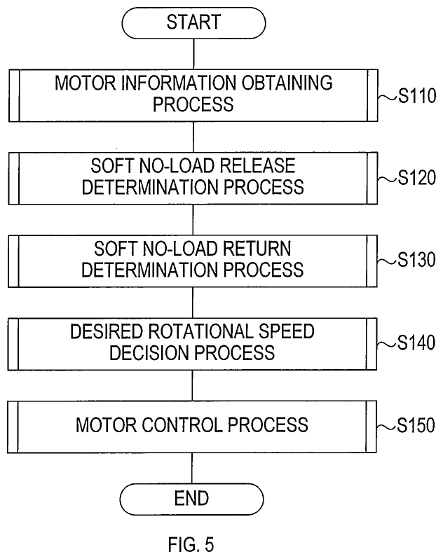

Main process executed by the control circuit 30 (specifically, the CPU30a) will be described with reference to FIGS. 5 to 8. The motor 10 is controlled by the main process. The above operational example of the motor 10 is implemented by the control circuit 30 executing the main process. In other words, the physical quantity obtainer 31, the variation obtainer 32, the soft no-load determiner 33, the drive controller 34, and the rotational speed calculator 35 illustrated in FIG. 2 are implemented by executing the main process. The program of the main process is stored in, for example, the memory 30b.

After being activated, the control circuit 30 repeatedly executes the main process at a predetermined control cycle. When starting the main process, the control circuit 30 executes a motor information obtaining process in S110. Specifically, the control circuit 30 obtains the pulling amount of the trigger 6, the maximum rotational speed selected by the speed adjustment dial 7, the actual rotational speed of the motor 10, the motor current value, the electric current variation, and the like.

Although not illustrated in FIG. 5, a predetermined initial process is executed after the start of the main process and before the process of S110. In this initial process, the motor 10 is handled as being in the no-load state. As a result, the soft no-load control is executed.

In S120, the control circuit 30 performs a soft no-load release determination process. Specifically, the control circuit 30 determines whether or not to release the soft no-load control. The process of S120 is performed in a case where the soft no-load control is being executed. In a case where the soft no-load control is not being executed (that is, in the load state), the process of S120 is not performed.

Specifically, in S120, the control circuit 30 determines whether or not the motor 10 is in the load state. When determining that the motor 10 is in the load state, the control circuit 30 decides to release the soft no-load control. In a case where the release decision is performed, a return determination to be described later is cancelled.

In S130, the control circuit 30 performs a soft no-load return determination process. Specifically, the control circuit 30 determines whether or not to return to the soft no-load control. The process of S130 is performed in a case where the soft no-load control is not being executed. In a case where the soft no-load control is being executed (that is, in the no-load state), the process of S130 is not performed.

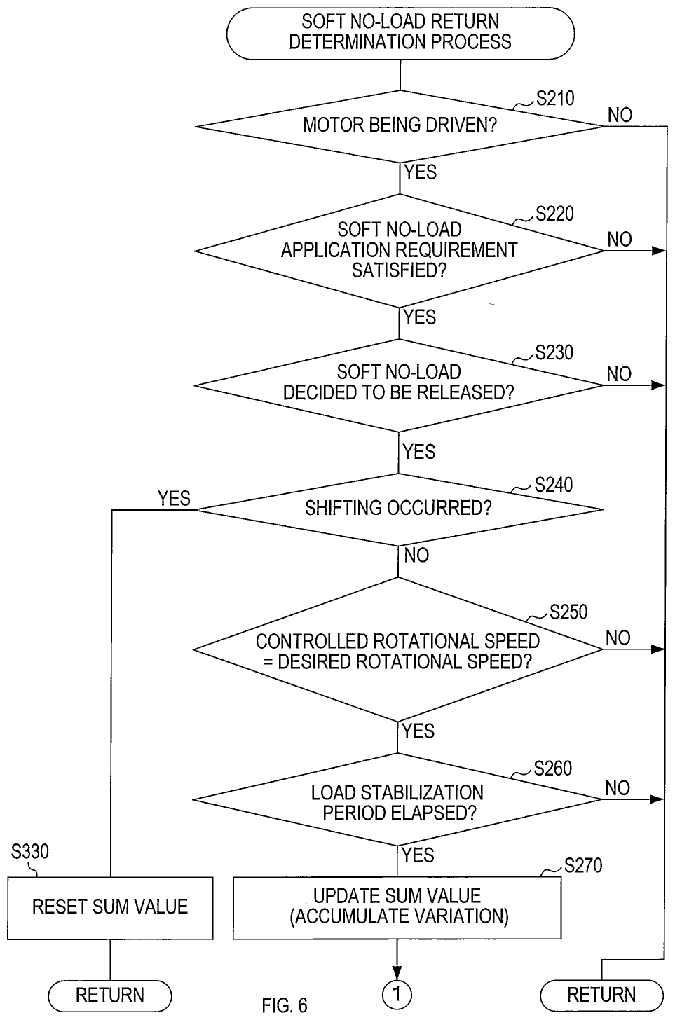

Specifically, in S130, the control circuit 30 determines whether or not the motor 10 is in the no-load state. When determining that the motor 10 is in the no-load state, the control circuit 30 decides (or determines) to return to the soft no-load control. Details of the process of S130 are illustrated in FIG. 6.

As illustrated in FIG. 6, when proceed to the soft no-load return determination process, the control circuit 30 determines whether or not the motor 10 is being driven in S210. The control circuit 30 can determine whether or not the motor 10 is being driven on the basis of whether or not a predetermined requirement is satisfied. The predetermined requirement may be based on various states of the electric work machine 1. The various states of the electric work machine 1 may include, for example, the operating state of the trigger 6 by the user. For example, it may be determined that the motor 10 is being driven on the basis of the fact that the trigger 6 is being pulled.

In a case where the motor 10 is stopped, the control circuit 30 terminates the soft no-load return determination process and proceeds to S140 (see FIG. 5). In a case where the motor 10 is being driven, the control circuit 30 determines whether a soft no-load application requirement is satisfied in S220. The soft no-load application requirement is required to determine that the soft no-load control is executable. In the present embodiment, the soft no-load application requirement is satisfied on the basis of the fact that the pulling amount of the trigger 6 is larger than or equal to the predetermined pulling amount.

In a case where the soft no-load application requirement is not satisfied in S220, the control circuit 30 terminates the soft no-load return determination process and proceeds to S140. That is, in a case where the soft no-load application requirement is not satisfied, the soft no-load control is not executed even if the motor 10 is in the no-load state. In a case where the soft no-load application requirement is satisfied, the process proceeds to S230.

In S230, the control circuit 30 determines whether or not the soft no-load control is decided to be released. In a case where the soft no-load control is not decided to be released (that is, in a case where the load state is not detected), the control circuit 30 terminates the soft no-load return determination process and proceeds to S140. In a case where the soft no-load control is decided to be released (that is, in a case where the load state is detected), the process proceeds to S240.

In S240, the control circuit 30 determines whether or not shifting has occurred. For example, the control circuit 30 may determine that shifting has occurred on the basis of the fact that the shift operation has been performed by the user. Alternatively, the control circuit 30 may determine that shifting has occurred on the basis of the fact that the desired rotational speed is actually changed in response to the shift operation.

In a case where shifting has occurred, the process proceeds to S330. In S330, the control circuit 30 resets the sum value currently calculated. After the sum value is reset in S330, the calculation of the sum value is stopped until the second period elapses. In other words, the electric current variation during the second period is excluded from the calculation of the sum value. That is, the electric current variation is not accumulated in the second period. When the second period elapses after the sum value is reset, an affirmative determination is performed in S260 to be described later, and the calculation of the sum value is restarted in S270. After the process of S330, the process proceeds to S140.

In a case where shifting has not occurred in S240, the process proceeds to S250. In S250, the control circuit 30 determines whether or not the controlled rotational speed reaches the desired rotational speed. In a case where the controlled rotational speed does not reach the desired rotational speed, the process proceeds to S140. When the soft no-load control is released, the controlled rotational speed gradually approaches the desired rotational speed. Even when shifting is performed, the controlled rotational speed gradually approaches a new desired rotational speed after shifting. Therefore, a negative determination is performed in S250 until the desired arrival timing after the soft no-load control is released or after shifting is performed. In a case where the controlled rotational speed reaches the desired rotational speed, the process proceeds to S260.

In S260, the control circuit 30 determines whether or not the load stabilization period has elapsed from the desired arrival timing. In other words, in S260, after the soft no-load control is released, the control circuit 30 determines whether or not the first standby time has elapsed from the desired arrival timing. After shifting, the control circuit 30 determines whether or not the second standby time has elapsed from the desired arrival timing. As described above, in the present embodiment, the first standby time is the same as the second standby time.

In a case where the load stabilization period has not elapsed in S260, the process proceeds to S140. When the load stabilization period has elapsed in S260, the process proceeds to S270.

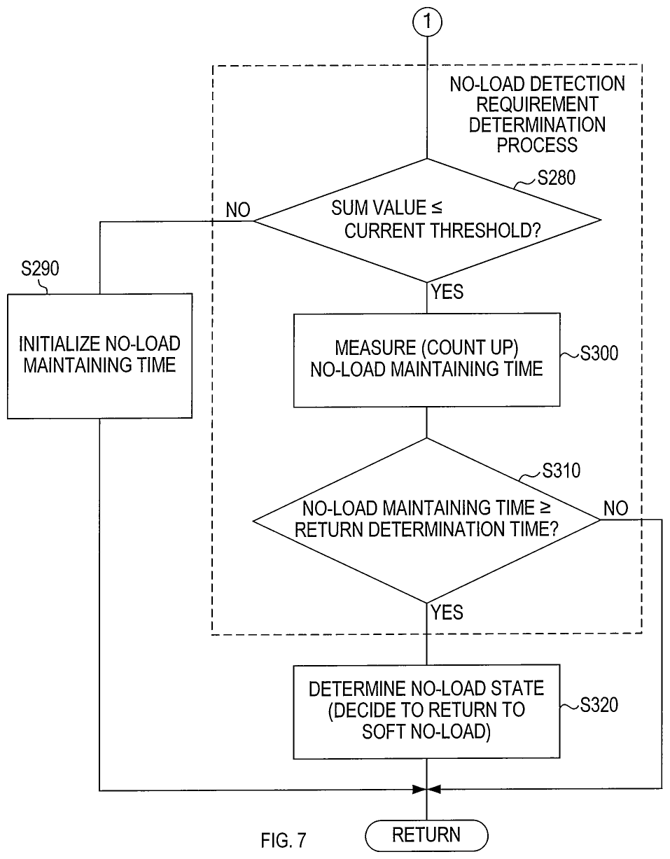

In S270, the control circuit 30 updates the sum value. That is, the control circuit 30 accumulates the electric current variation. When the process proceeds to S270 for the first time after shifting is performed, the sum value is reset. For this reason, in this case, the calculation of the sum value is restarted from the reset value (for example, zero). After the process of S270, the process proceeds to a no-load detection requirement determination process (see FIG. 7). The no-load detection requirement determination process includes S280, S300, and S310. The no-load detection requirement determination process includes determining whether or not the no-load detection requirement is satisfied.

In S280, the control circuit 30 determines whether or not the sum value currently calculated is less than or equal to the current threshold. In a case where the sum value is larger than the current threshold, the process proceeds to S290. In S290, the control circuit 30 resets a no-load maintaining time (for example, resets the no-load maintaining time to zero). The no-load maintaining time is a time period during which a state where the sum value is less than or equal to the current threshold is maintained. The beginning of the no-load maintaining time is a timing when an affirmative determination is performed in S280 (it is necessary that a negative determination is performed in previous S280). In other words, the beginning of the no-load maintaining time corresponds to a time point at which the sum value larger than the current threshold is changed to be less than or equal to the current threshold. After the process of S290, the process proceeds to S140.

In a case where the sum value is less than or equal to the current threshold, the control circuit 30 measures the no-load maintaining time in S300. Specifically, the current no-load maintaining time is increased (counted up), thereby updating the no-load maintaining time.

In S310, the control circuit 30 determines whether or not the current no-load maintaining time is longer than or equal to the return determination time. In a case where the no-load maintaining time has not yet reached the return determination time, the process proceeds to S140. In a case where the no-load maintaining time is longer than or equal to the return determination time, the process proceeds to S320. The case where the no-load maintaining time is longer than or equal to the return determination time corresponds to the fact that the no-load detection requirement is satisfied.

In S320, the control circuit 30 (i) determines that the motor 10 is in the no-load state, and (ii) decides to return to the soft no-load control on the basis of the determination. In a case where the return decision is performed after the release decision is performed, the release decision is cancelled. After the process of S320, the process proceeds to S140.

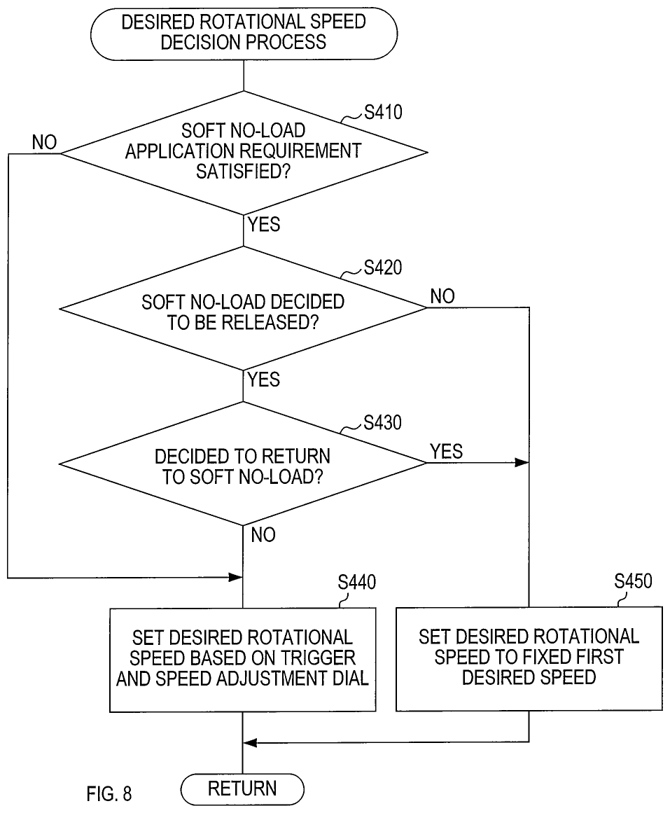

In S140 (see FIG. 5), the control circuit 30 performs a desired rotational speed decision process. Details of the desired rotational speed decision process are illustrated in FIG. 8. When proceeding to the desired rotational speed decision process, the control circuit 30 determines whether or not the soft no-load application requirement is satisfied in S410. The process in S410 is the same as that in S220. In a case where the soft no-load application requirement is not satisfied, the process proceeds to S440. In a case where the soft no-load application requirement is satisfied, the process proceeds to S420.

In S420, the control circuit 30 determines whether or not the soft no-load control is decided to be released. In a case where the soft no-load control is not decided to be released, the process proceeds to S450. For example, immediately after the start of drive of the motor 10 or in a case where the motor 10 is determined to be in the no-load state, it is determined that the soft no-load control is not decided to be released in S420.

In S450, the control circuit 30 sets the desired rotational speed to the first rotational speed. That is, the control circuit 30 sets the desired rotational speed used in the soft no-load control. After the process of S450, the process proceeds to S150 (see FIG. 5).

In a case where the soft no-load control is decided to be released in S420, the process proceeds to S430. In S430, the control circuit 30 determines whether or not it is decided to return to the soft no-load control. In a case where it is decided to return to the soft no-load control, the process proceeds to S450. In this case, the desired rotational speed is set to the first rotational speed corresponding to the soft no-load control.

In a case where it is not decided to return to the soft no-load control, the process proceeds to S440. In S440, the control circuit 30 sets the desired rotational speed based on the trigger 6 and the speed adjustment dial 7. After the process of S440, the process proceeds to S150.

In S150 (see FIG. 5), the control circuit 30 executes a motor control process. Specifically, the control circuit 30 sets the controlled rotational speed on the basis of the desired rotational speed currently set. The control circuit 30 calculates the duty ratio on the basis of the controlled rotational speed and the actual rotational speed. The control circuit 30 outputs the drive command to the drive circuit 21, thereby driving the motor 10.

### (2-5) Correspondence Relationship of Words

In the above embodiment, the trigger 6 and the speed adjustment dial 7 correspond to an example of at least one switch in the overview of the embodiment. The trigger 6 corresponds to an example of the first switch in the overview of the embodiment. The speed adjustment dial 7 corresponds to an example of the second switch in the overview of the embodiment. The second standby time corresponds to an example of the standby time in the overview of the embodiment. The current threshold corresponds to an example of the predetermined threshold in the overview of the embodiment. The return determination time corresponds to an example of the determination time in the overview of the embodiment.

### 3. Other Embodiments

Although the embodiment of the present disclosure has been described above, the present disclosure is not limited to the above embodiment, and various modifications can be made.

(3-1) In the above embodiment, in a case where the shift operation is performed, (i) the sum value currently calculate is reset, and (ii) the accumulation of the electric current variation is avoided until the second period elapses (that is, the electric current variation during the second period is excluded from the sum value).

However, the calculation of the sum value in a case where the shift operation is performed may be performed by another method. In other words, the electric current variation may be excluded from the calculation of the sum value in the second period in any manner.

For example, resetting the sum value is not essential. Specifically, the sum value at the time when the shift operation is performed may be maintained during the second period. Then, after the second period elapses, the accumulation of the electric current variation may be restarted from the sum value maintained.

Furthermore, for example, the sum value may be calculated by a method different from accumulation. For example, the sum value of the electric current variations in the first period may be calculated one by one every time the detection timing arrives. Then, in a case where the shift operation is performed, the beginning of the first period may be changed from the first calculation start timing to the second calculation start timing. The second calculation start timing corresponds to the end of the second period.

(3-2) The second period may be decided in any manner. The second period does not need to include, for example, the second standby time.

(3-3) The sum calculator 40 may calculate the sum value of other variations different from the electric current variation. The soft no-load determiner 33 may determine the no-load state of the motor 10 on the basis of the sum value of the other variations.

The other variation may be a variation of a predetermined physical quantity. The predetermined physical quantity is (i) different from the motor current and (ii) related to the operating state of the motor 10. The predetermined physical quantity may include a parameter used for controlling the motor 10. The predetermined physical quantity may be, for example, the actual rotational speed of the motor 10, a voltage applied or being applied to the motor 10, or the duty ratio of the PWM signal.

(3-4) The desired rotational speed set in the soft no-load control does not need to be fixed. The desired rotational speed may also vary at the time of executing the soft no-load control. For example, the desired rotational speed may also vary depending on the variation in the pulling amount of the trigger 6. In this case, the desired rotational speed lower than the desired rotational speed set in a case where the soft no-load control is released may be set.

(3-5) The drive controller 34 may implement the soft no-load control in any manner. In the above embodiment, the target setter 41 plays a substantial role of the soft no-load control. That is, in the above embodiment, the target setter 41 sets the desired rotational speed to the first rotational speed in response to the no-load detection requirement being satisfied.

On the other hand, for example, the controlled rotational speed setter 42 may play a substantial role of the soft no-load control. Specifically, in response to the no-load detection requirement being satisfied, the controlled rotational speed setter 42 may set the controlled rotational speed to a fixed speed regardless of the desired rotational speed currently set.

Alternatively, the motor controller 43 may play a substantial role in the soft no-load control. Specifically, in response to the no-load detection requirement being satisfied, the motor controller 43 may control the motor 10 at a fixed speed regardless of the desired rotational speed and the controlled rotational speed. Specifically, the motor controller 43 may generate the drive command to rotate the motor 10 at the first rotational speed.

(3-6) It is not essential to gradually bring the controlled rotational speed close to the desired rotational speed in response to the change in the desired rotational speed. The controlled rotational speed may always match the desired rotational speed. In other words, the controlled rotational speed setter 42 may be omitted. In this case, the motor controller 43 may control the motor 10 based on the desired rotational speed set by the target setter 41.

(3-7) The trigger 6 or the speed adjustment dial 7 may be omitted. “At least one switch” in the overview of the embodiment may be implemented in a form different from the trigger 6 and the speed adjustment dial 7.

(3-8) The motor 10 of the above embodiment is in the form of a three-phase brushless motor. However, the motor of the present disclosure may have a form different from the three-phase brushless motor (for example, a brushed DC motor, various AC motors, and the like).

(3-9) A plurality of functions of one component in the above embodiment may be implemented by a plurality of components, or one function of one component may be implemented by a plurality of components. In addition, a plurality of functions of a plurality of components may be implemented by one component, or one function implemented by a plurality of components may be implemented by one component. A part of the configuration of the above embodiment may be omitted. At least a part of the configuration of the above embodiment may be added to or replaced with another configuration of the above embodiment.

What is claimed is:

1. An electric work machine comprising:
a motor configured to drive a driven tool attached to the electric work machine;
a drive circuit configured to drive the motor; and
a control circuit including:
a physical quantity obtainer configured to obtain a physical quantity every time a detection timing arrives, the physical quantity being related to an operating state of the motor,
a variation obtainer configured to obtain a variation every time the detection timing arrives, the variation corresponding to an increased amount of the physical quantity from that obtained at the detection timing of last time to that obtained at the detection timing of this time,
a sum calculator configured to calculate a sum value every time the detection timing arrives, the sum value corresponding to a sum of one or more variations, each of the one or more variations corresponding to the variation obtained at the corresponding detection timing during a first period, and the first period being from a first calculation start timing to the detection timing of this time, and
a drive controller configured to control the motor in accordance with a first control system via the drive circuit based on the sum value calculated by the sum calculator having satisfied or satisfying a no-load detection requirement, the no-load detection requirement being required to detect no application of a load to the motor.

2. The electric work machine according to claim 1, further comprising at least one switch configured to be manually operated by a user of the electric work machine, wherein
the control circuit further includes a target setter configured to set a desired rotational speed of the motor based on a state of the at least one switch, and
the drive controller is configured to control the motor in accordance with a second control system based on the sum value not satisfying the no-load detection requirement, and the second control system (i) being different from the first control system, and (ii) including controlling the motor so as to rotate the motor at the desired rotational speed set by the target setter.

3. The electric work machine according to claim 2, wherein
the sum calculator is configured to exclude the variation obtained by the variation obtainer during a second period from calculation of the sum value based on the desired rotational speed being changed by the at least one switch, the second period corresponds to from a shift timing to a predetermined timing, and the shift timing corresponds to a timing when the desired rotational speed is changed.

4. The electric work machine according to claim 3, wherein
the sum calculator is configured to switch beginning of the first period from the first calculation start timing to a second calculation start timing based on the desired rotational speed being changed by the at least one switch, and
the second calculation start timing corresponds to the predetermined timing.

5. The electric work machine according to claim 3, wherein
the control circuit further includes a controlled rotational speed setter configured to (i) set a controlled rotational speed based on the desired rotational speed, and (ii) gradually change, based on the desired rotational speed being changed, the controlled rotational speed to the desired rotational speed changed,
the second control system controlling the motor so that an actual rotational speed of the motor is consistent with the controlled rotational speed, and
the second period includes a desired arrival period, the desired arrival period corresponds to a time period from the shift timing to a desired arrival timing, and the desired arrival timing corresponds to a timing when the controlled rotational speed has reached to the desired rotational speed by the controlled rotational speed setter.

6. The electric work machine according to claim 5, wherein
the second period further includes a time period from the desired arrival timing until a standby time elapses.

7. The electric work machine according to claim 1, wherein
the sum calculator is configured to, in the first period, accumulate the variation every time the detection timing arrives to thereby calculate the sum value.

8. The electric work machine according to claim 2, wherein
the sum calculator is configured to, in the first period, accumulate the variation every time the detection timing arrives to thereby calculate the sum value, and
the sum calculator is configured to reset the sum value currently calculated based on (i) the at least one switch being manually operated and (ii) to thereby the desired rotational speed being changed.

9. The electric work machine according to claim 2, wherein
the at least one switch includes a first switch, and
the target setter is configured to change the desired rotational speed based on a position of the first switch.

10. The electric work machine according to claim 9, wherein
the at least one switch includes a second switch, and
the target setter is configured to change the desired rotational speed with a maximum rotational speed as an upper limit, and the maximum rotational speed is determined based on a position of the second switch.

11. The electric work machine according to claim 1, wherein
the no-load detection requirement is satisfied based on the sum value calculated by the sum calculator having a predetermined magnitude, and the predetermined magnitude corresponds to a magnitude less than or equal to a predetermined threshold.

12. The electric work machine according to claim 1, wherein
the no-load detection requirement is satisfied based on the sum value calculated by the sum calculator having a predetermined magnitude, and the predetermined magnitude corresponds to a magnitude greater than or equal to a predetermined threshold.

13. The electric work machine according to claim 11, wherein
the no-load detection requirement is satisfied based on the sum value calculated by the sum calculator continuing to maintain the predetermined magnitude for a determination time.

14. The electric work machine according to claim 1, wherein
the first control system includes rotating the motor at a first rotational speed, and the first rotational speed is constant.

15. The electric work machine according to claim 2, wherein
the first control system includes rotating the motor at a first rotational speed, and
the first rotational speed is (i) constant and (ii) lower than the desired rotational speed.

16. The electric work machine according to claim 1, wherein
the physical quantity includes an electric current flowing through the motor.

17. A motor control method used in an electric work machine, the motor control method comprising:
obtaining a physical quantity every time a detection timing arrives, the physical quantity being related to an operating state of a motor, and the motor being provided in the electric work machine;
obtaining a variation every time the detection timing arrives, the variation corresponding to an increased amount of the physical quantity from that obtained at the detection timing of last time to that obtained at the detection timing of this time;
calculating a sum value every time the detection timing arrives, the sum value corresponding to a sum of one or more variations, and each of the one or more variations corresponding to the variation obtained at the corresponding detection timing during a first period; and
controlling the motor in accordance with a control system based on the sum value.
